(19) United States
(12) Patent Application Publication
(10) Pub. No.: US 2011/0104645 A1
(43) Pub. Date: May 5, 2011

(54) BOOK CONTAINING EDUCATION MEANS FOR TEACHING PROFESSIONAL CALCULATOR AND FINANCE TRAINING SIMULATION METHOD USING THE SAME

(76) Inventor: Dae Hyun Kim, Seoul (KR)

(21) Appl. No.: 12/935,957

(22) PCT Filed: May 26, 2008
(86) PCT No.: PCT/KR2008/002934

§ 371 Date: Dec. 3, 2010

(30) Foreign Application Priority Data
Apr. 3, 2008 (KR) 10-2008-0031094
Apr. 30, 2008 (KR) 10-2008-0040813

(51) Int. Cl. G09B 19/18

(52) U.S. Cl. 434/107

(57) ABSTRACT

Disclosed herein are financial calculator teaching material and a financial education simulation method. The financial calculator teaching material for teaching usage of a financial calculator, including a financial situation presentation section provided in story form, a fund calculation process presentation section for presenting a fund calculation procedure, including one or more calculation processes, in order to enable fund calculation to be performed for a financial situation presented by the financial situation presentation section, a fund calculation performance result display section for providing result values of the fund calculation for the financial situation in image form and/or in chart form, and a financial calculator usage presentation section for providing usage of a preset type of financial calculator in order to enable fund calculation to be performed for the financial situation.

### TECHNICAL FIELD

The present invention relates generally to teaching material including means for teaching the effective usage of a financial calculator, and, more particularly, to teaching material for teaching the usage of a financial calculator, which provides information about the sequence of pressing buttons for each type of financial calculator with respect to a story related to each financial situation actually encountered by the users of the financial calculator, and a financial education simulation method which presents cases required for the performance of various types of financial calculations using the financial calculator and intuitively displays financial calculation results, thereby providing desired simulation results to persons who utilize the financial calculator in performing their work and persons who want to perform calculations regarding a pension, a loan, a periodic rate of return, a retirement plan, a targeted fund, a guaranteed fund and a retirement fund.

### BACKGROUND ART

Financial calculators were designed to handle the accounts and financial affairs of corporations. Financial calculators are equipped with buttons for processing various types of functions and equations, unlike calculators for generally doing addition, subtraction, division and multiplication. Accordingly, financial calculators are chiefly used to calculate a simple interest rate, a compound interest rate, the rate of return of a pension, a loan period and the future value of a current fund, and are being used by the accountants of corporations. Although the functions of financial calculators include most of the functions required by corporate accountants, a considerable number of accountants are using the financial calculators for only part of their work. This is because they do not know the correct usage of financial calculators and it is difficult to make an accurate determination about which functions of the financial calculators are applied to specific cases.

It is difficult to use financial calculators and to understand how to apply them to situations. Although companies which sell or distribute financial calculators explain the usage of the financial calculators in the form of manuals, most manuals are prepared for a number of unspecified users and describe only the usage of financial calculators such as the functions of the buttons of the financial calculators and the sequences of pressing the buttons, so that it is difficult to use the manuals for actual accounts.

Furthermore, in order to successfully use financial calculators, learners must be accustomed not only to the physical usage of the financial calculators (such as how to press the buttons and how to use the functions), but also to the usage of the financial calculators for each specific financial situation. Financial situations vary depending on the financial purposes of the users of the financial calculators or the financial purposes of the customers of the users of the financial calculators. It is apparent that using financial calculator manuals to describe functions significantly limits the successful use of the financial calculators for various financial situations and financial purposes.

As described above, the reasons why the accountants of corporations or the users of financial calculators have difficulty with the use of the financial calculators are as follows:
they do not know situations to which financial calculators are to be applied nor how to apply financial calculators to the respective situations,
it is difficult to expect results for each financial situation based on selected function and number buttons,
they cannot be confident that the results of their calculation are correct, and
it is difficult to be intuitively aware of calculation results and processes.

Accordingly, the present applicant intends to propose teaching material and financial education simulation method which provide teaching material and simulation related to financial calculators to persons who want to learn the cases of use of financial calculators and the usage of the financial calculators or to persons who do not know the usage of the financial calculators but want to intuitively obtain calculation results, and which present the results thereof.

### DISCLOSURE

### Technical Problem

Accordingly, the present invention has been made keeping in mind the above problems occurring in the prior art, and a first technical object of the present invention is to provide teaching material for teaching the usage of a financial calculator, which provides information about the sequence of pressing buttons for each type of financial calculator with respect to a story related to each financial situation actually encountered by the users of the financial calculator.

A second technical object of the present invention is to provide a method of extracting information about the fund calculation for each story and teaching material for enabling the effective learning of a fund calculation process.

A third technical object of the present invention is to provide teaching material which provides a cash flow, so that a learner can intuitively understand financial calculation results, and which includes fund calculation processes, a fund calculation sequence and description for each of the processes, and screens displaying the usage of the financial calculator and actual examples of the usage for each type of financial calculator using an actual financial calculator, so that they are presented for each of the processes and each sequential position, thereby enabling the learner to effectively learn the usage of the financial calculator.

A fourth technical object of the present invention is to provide a financial education simulation method which provides examples of consultation with customers or stories similar to actual situations, and also provides an interface having a structure similar or identical to that of the financial calculator to a learner who wants to learn the usage of the financial calculator, and which enables the learner to practice the financial calculator in situations similar to actual situations.

A fifth technical object of the present invention is to provide a financial education simulation method which presents a previously prepared story for each financial situation to a general user who cannot use the financial calculator at all and enables required financial information to be acquired only through a process in which the general user inputs only required numbers.

### Technical Solution

In order to accomplish the above objects, the present invention provides financial calculator teaching material for teaching usage of a financial calculator, including a financial situation presentation section provided in story form; a fund calculation process presentation section for presenting a fund calculation procedure, including one or more calculation processes, in order to enable fund calculation to be performed for a financial situation presented by the financial situation presentation section; a fund calculation performance result display section for providing result values of the fund calculation for the financial situation in image form and/or in chart form; and a financial calculator usage presentation section for providing usage of a preset type of financial calculator in order to enable fund calculation to be performed for the financial situation.

In order to accomplish the above objects, the present invention provides a financial education simulation method, the financial education simulation method being performed through a server connected to a user terminal over a network, the method including posting a story for each financial situation on a side of a webpage; displaying a calculator menu, including buttons for inputting numbers and function values and having a financial calculator form, on a side of a webpage; when buttons provided in the calculator menu are selected through the user terminal connected over the network in accordance with the story, providing a cash flow diagram related to variation in fund to the webpage in accordance with the buttons through the user terminal; and when an error occurs in any one of a number and a function input through the user terminal, providing notification of the occurrence of the error to the user terminal and requesting correction of the error.

In order to accomplish the above objects, the present invention provides a financial education simulation method, the financial education simulation method being performed through a server connected to a user terminal over a network, the method including posting a story for each financial situation on a side of a webpage; displaying a calculator menu, including buttons for inputting numbers and function values and having a financial calculator form, on a side of a webpage; displaying a cash flow diagram, indicating an initial value and final value of a fund calculated based on the financial situation and a flow of a period required for the variation in the fund, on the webpage; and when a period and a size of the fund assigned to the financial situation are changed through the user terminal connected over the network, creating the cash flow diagram corresponding to the period and size and providing the cash flow diagram to the user terminal.

In order to accomplish the above objects, the present invention provides a financial education simulation method, the financial education simulation method being performed through a server connected to a user terminal over a network, the method including posting a story for each financial situation on a side of a webpage; displaying a calculator menu, including buttons for inputting numbers and function values and having a financial calculator form, on a side of a webpage; leaving areas for an amount of money and periods of the story blank, and allowing numbers to be entered in the areas through the user terminal connected over the network; displaying a cash flow diagram, indicating an initial value and final value of a fund calculated based on the financial situation and a flow of a period required for the variation in the fund, on the webpage; and when numbers are entered in the areas through the user terminal, updating the cash flow diagram in accordance with the numbers entered through the user terminal.

In order to accomplish the above objects, the present invention provides a computer-readable storage medium for storing a method performed in a computer including a processor and memory, the method including the steps of posting a story for each financial situation on a monitor; displaying a calculator menu, including buttons for inputting numbers and function values and having a financial calculator form, on the monitor; and displaying a cash flow diagram, indicating variation in fund using an area graph, in accordance with a fund and a function selected through the calculator menu.

### ADVANTAGEOUS EFFECTS

Accordingly, the present invention provides the effects of:
presenting stories based on actual life and situations to learners and prompting the learners to select the functions and numerical values of a financial calculator, thereby increasing learning effects.
representing the result values of the financial calculator in the form of images and a chart, thereby enabling learners to intuitively understand financial results. Here, the result values of the financial calculator presented in the form of images are proportional to current and future values in area, height and/or width, thereby improving the learners' intuitive awareness.
sequentially displaying the selections of the functions and numerical values of the financial calculator, thereby enabling learners to easily use the financial calculator.
presenting stories similar to actual situations to learners who learn the usage and utilization of the financial calculator and make the learners adapt themselves to stories, thereby enabling the learners to learn the usage of the financial calculator.
presenting a story for each case to general users who have no knowledge of the usage of a financial calculator and financial affairs and enabling the users to be aware of various types of desired financial situations by filling in the blank items of the story.

### DESCRIPTION OF DRAWINGS

FIG. 1 is a diagram showing an embodiment of material for teaching the usage of a financial calculator in which the spirit of the present invention has been implemented;

FIG. 2 is an enlarged diagram showing the financial situation presentation section, fund calculation numerical element display section and fund calculation process presentation section of FIG. 1;

FIG. 3 is an enlarged diagram showing the fund calculation performance result display section and calculation process description section of FIG. 1;

FIG. 4 is an enlarged diagram showing the financial calculator usage presentation section of FIG. 1;

FIG. 5 is a view of another embodiment to which the spirit of the present invention has been applied, in which a financial calculator mode display section exists and the usage of a financial calculator is presented for each mode;

FIG. 6 is an enlarged view of the financial calculator usage presentation section shown in FIG. 5;

FIGS. 7 to 14 are diagrams of a series of implementation examples of the spirit of the present invention for one composite financial consultation case, showing that the financial situation presentation section is shown across FIGS. 7 to 8 and the spirit of the present invention has been applied to three respective detailed financial consultation topics with regard to the financial situation presentation section;

FIG. 15 is a conceptual diagram showing a financial education simulation method according to an embodiment of the present invention;

FIG. 16 is a conceptual diagram showing a financial education simulation method according to another embodiment of the present invention;

FIGS. 17 to 19 are diagrams schematically illustrating the cash flow diagram processing method of the financial education simulation method according to the present invention;

FIG. 20 is a drawing showing an example of a story list that a server presents to a user terminal;

FIG. 21 is a schematic block diagram of a server according to an embodiment of the present invention;

FIG. 22 is a drawing showing an example of an interface provided by a web service module; and

FIG. 23 is a diagram showing an example in which a cash flow diagram according to the present invention is represented based on the story.

### DESCRIPTION OF PRINCIPAL ELEMENTS IN THE DRAWINGS

10: financial situation presentation section

20: fund calculation process presentation section

30: fund calculation performance result display section

40: financial calculator usage presentation section

50: fund calculation numerical element display section

60: calculation process description section

70: financial calculator result screen display section

80: additional description section

90: financial calculator mode display section

### MODE FOR INVENTION

The present invention complies with the following items.

1) Material for teaching a financial calculator (hereinafter referred to as “finance teaching material”) proposed by the present invention may be online teaching material or offline teaching material. If the finance teaching material proposed by the present invention is online teaching material, a financial education simulation may be conducted by a server that presents financial situations based on the finance teaching material to a user terminal connected over a network and returns result values to the user terminal when functions or numbers suitable for each of the financial situations are selected through the user terminal.

2) A financial education simulation method proposed by the present invention is performed by the server connecting to the user terminal over a network.

3) A result value provided by the server to the user terminal is provided in such a way that the size of the result value, a period for which the result value was calculated and the variation of the result value over time are represented in the form of a chart (hereinafter referred to as a cash flow diagram), so that a learner can intuitively understand a financial situation and the variation in the fund. This is applied both to the finance teaching material and to the financial education simulation method.

4) The financial education simulation method proposed by the present invention may be installed and implemented in the user terminal in the form of a program. In this case, the program inherits functions from the server. Here, although the program may inherit overall functions from the server, it may not inherit one or more functions unnecessary for a client side, like a web service function.

The present invention will be described below with reference to the accompanying drawings. The finance teaching material and the financial education simulation method using the finance teaching material will be sequentially described below.

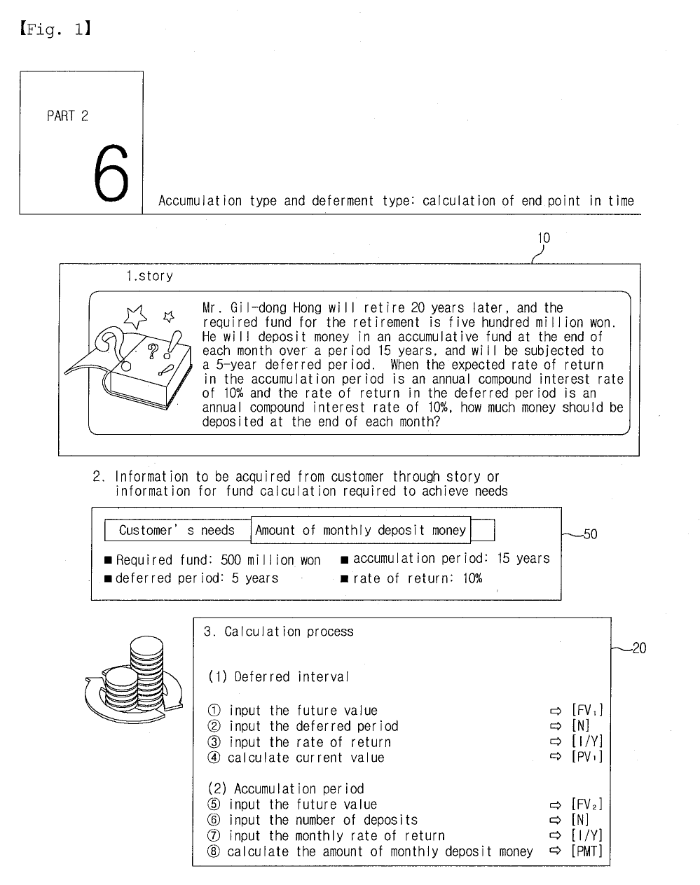

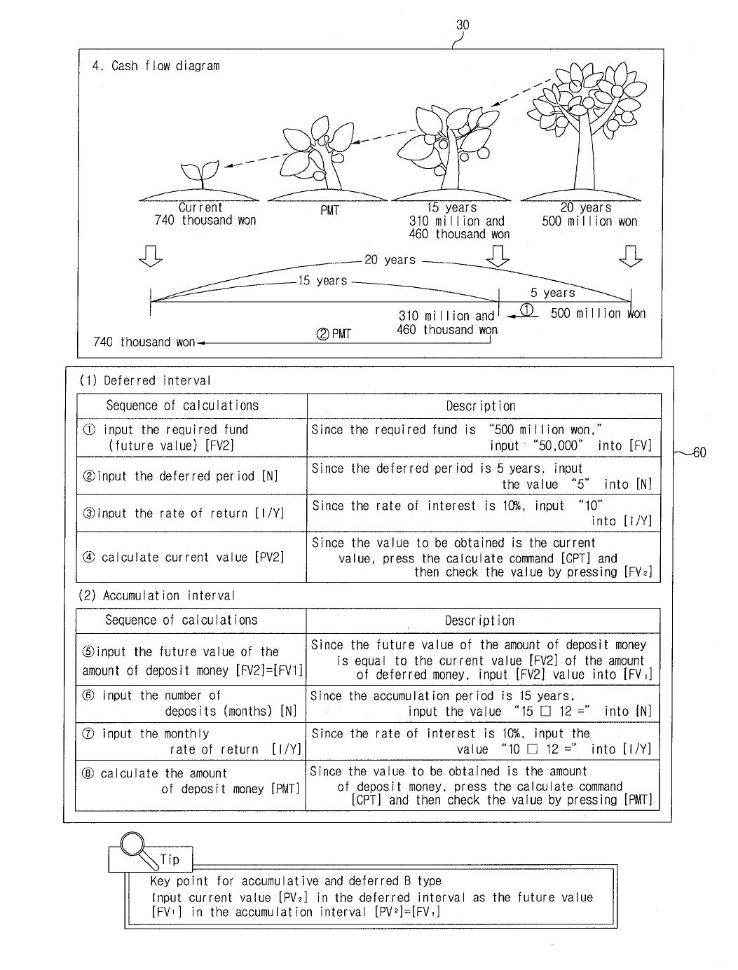

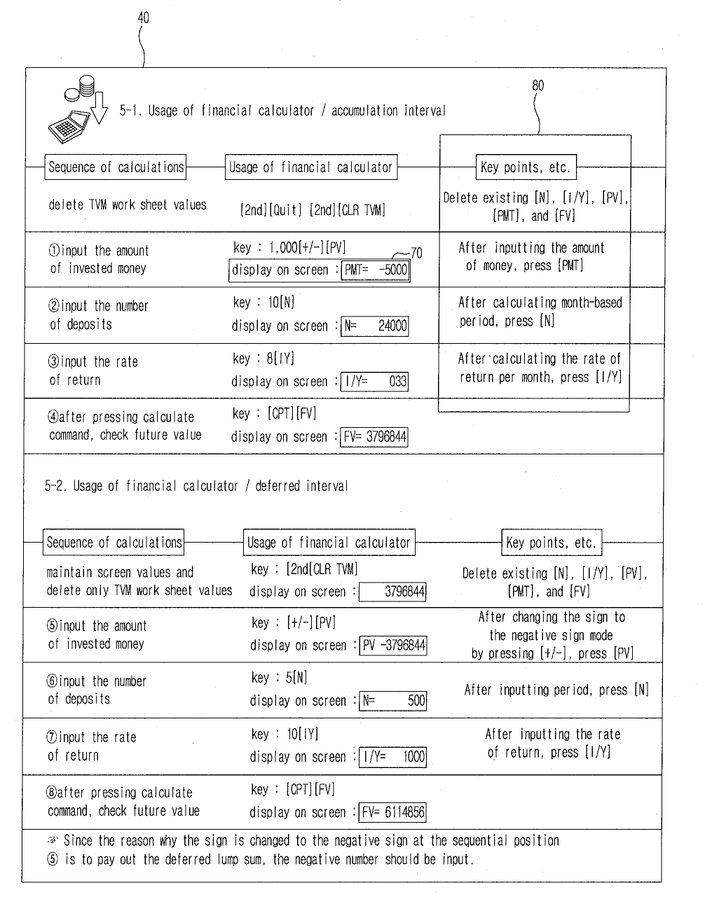

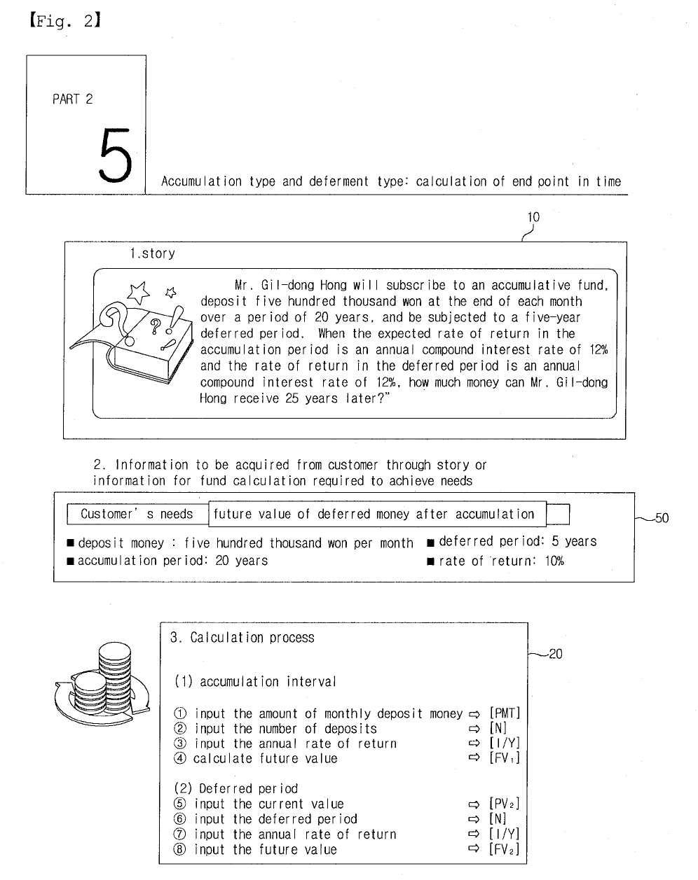

FIG. 1 is a diagram showing an example of the construction of material for teaching the usage of a financial calculator (hereinafter referred to as “finance teaching material”) according to the present invention, and FIGS. 2 to 4 are enlarged views of FIG. 1.

The illustrated finance teaching material includes a financial situation presentation section 10, a fund calculation process presentation section 20, a fund calculation performance result display section 30, a financial calculator usage presentation section 40, a fund calculation numerical element display section 50, a calculation process description section 60, a financial calculator result screen display section 70, and an additional description section 80.

Prior to a description thereof,

FIG. 2 is an enlarged diagram showing the financial situation presentation section 10, fund calculation numerical element display section 50 and fund calculation process presentation section 20 of FIG. 1,

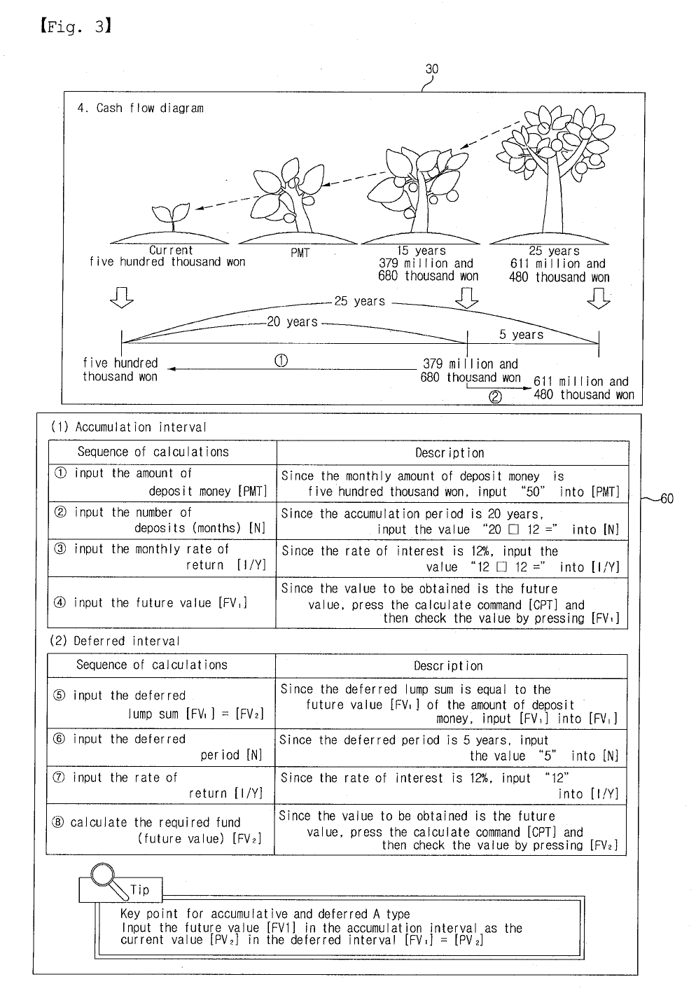

FIG. 3 is an enlarged diagram showing the fund calculation performance result display section 30 and calculation process description section 60 of FIG. 1, and

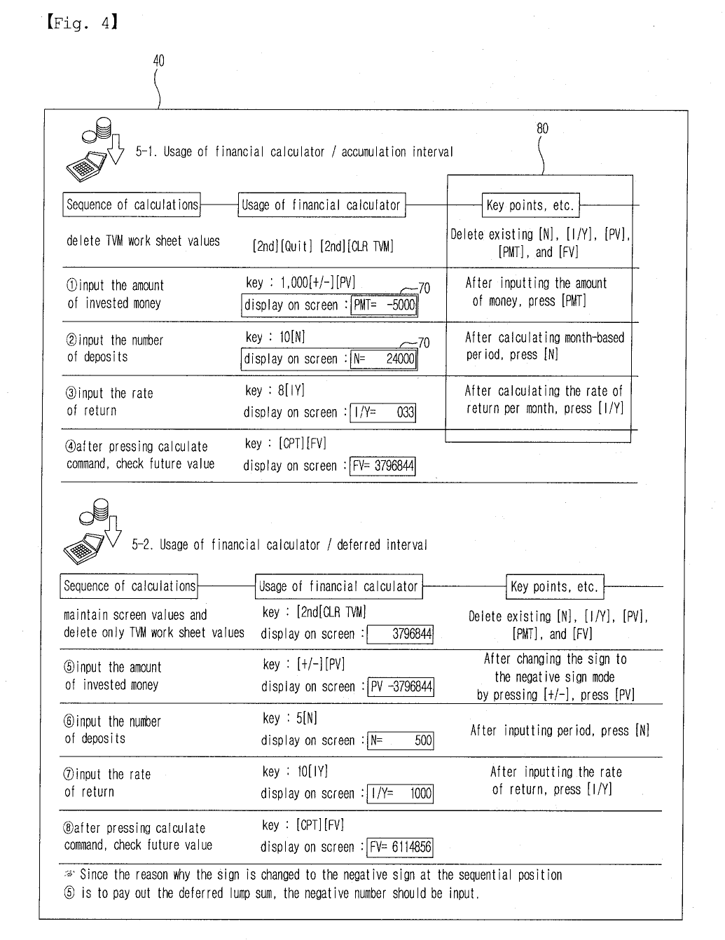

FIG. 4 is an enlarged diagram showing the financial calculator usage presentation section 40 of FIG. 1.

Accordingly, a description of respective elements of FIG. 1 will be given with reference to FIG. 1 along with FIGS. 2 to 4.

The financial situation presentation section 10 presents a case of a financial situation which may actually occur in the form of a story.

In the drawing, a story reads: “Mr. Gil-dong Hong will retire 20 years later, and the required fund for the retirement is five hundred million won. He will deposit money in an accumulative fund over a period 15 years . . . . ” As described above, the financial situation is presented in the form of a story which could be easily encountered in everyday life, so that a learner who makes a financial calculation using a financial calculator can immediately understand the financial situation.

The fund calculation numerical element display section 50 displays various types of numerical values for a financial situation included in the story, for example, periods, the amount of money, the rate of interest, the rate of return and the value corresponding to the story.

The story stored in the financial situation presentation section 10 enables a learner to understand and grasp a financial situation, and includes numerical values corresponding to the financial situation. After the learner has understood the financial situation through the story, the learner must determine how to apply the financial situation to the financial calculator.

The fund calculation numerical element display section 50 displays numerical values for respective items included in the story using terms and corresponding numerical values suitable for financial calculation. In this drawing, the situation is summarized and presented as follows: the required fund is five hundred million won, the accumulation period is 15 years, the deferred period is 5 years, and the rate of return is 10%. After the learner has determined the schematic situation through the story, the learner can determine how to apply the story to the financial calculator by referring to the numerical values for respective items summarised by the fund calculation numerical element display section 50. Furthermore, the financial calculator generally uses standardized terms, such as the required fund, the accumulation period, the deferred period and the rate of return, and the fund calculation numerical element display section 50 schematically summarizes a story using the standardized terms.

The fund calculation process presentation section 20 matches the numerical values, displayed based on the standard terms by the fund calculation numerical element display section 50, to the function values of the financial calculator, and displays them.

In the drawing, the numerical values of the story are divided into a deferment interval and an accumulation interval,
the deferment interval is assigned the items of the future value input PV, the deferred period input N, the rate of return input I/V and the current value calculation FV₁, and is configured to allow respective numerical values to be input to the financial calculator in the sequence of the future value input PV, the deferred period input N, the rate of return input I/V, and the current value calculation FV₁, and
the accumulation interval is assigned the items of the future value input FV₂, the number of accumulations input N, the monthly rate of return input I/V and monthly accumulated money calculation PMT, and is presented to allow respective numerical values to be input to the financial calculator in the sequence of the description.

The financial calculator usage presentation section 40 presents functions and numerical values that the learner should actually input to the financial calculator while referring to the story presented by the financial situation presentation section 10, the numerical values displayed by the fund calculation numerical element display section 50 and the fund calculation process presentation section 20. The financial calculator usage presentation section 40 gives numbers to the functions and the numerical values in the sequence of input, and arranges the functions and the numerical values that should be selected by the learner through the buttons of the actual financial calculator in the sequence of the numbers.

In the drawing, examples of the function and number buttons, such as “invested money input”, “number of deposits input”, “rate of return input”, . . . , “after pressing the calculate command, check the future value,” which should be selected in an actual financial calculator are illustrated.

When the learner inputs a function and numerical values to the actual financial calculator according to the story presented by the financial situation presentation section, the fund calculation performance result display section 30 displays corresponding result values. The displayed result values are represented in the form of a chart and images. Here, as shown in FIG. 3, an image is configured such that the area, height and width thereof linearly increase in proportion to current and future numerical values. FIG. 3 shows an example in which the size of a tree-shaped image is determined depending on 50 years, the amount of accumulated money PMT, 20 years and 25 years. Since the tree images are similar figures and the sizes (heights, widths and areas) thereof are determined in accordance with the amounts of money for corresponding periods, the flow of the amount of money is made to have consistency. The reason why the tree images are used is to enable the learner to immediately understand the increase or decrease in the amount of money by looking at the heights, widths or areas of the tree images. Accordingly, the fund calculation performance result display section 30 may display some other type of images, instead of the tree images. However, although any type of images are employed, the areas, heights or widths of the images should vary depending on the amount of money according to the variation in time or the amount of money.

The amount of money or the period corresponding to a tree image is indicated under the tree image, so that the learner can accurately understand the amount of money in question. Furthermore, a rectilinear graph-type chart is added in the lowest portion below the tree images. The chart is configured such that the amounts of money, periods or the rates of interest matched to the tree images are indicated on a lateral chart. Through this, the chart can represent temporal continuity that cannot be represented using only tree-shaped images and numerical values (the amounts of money, periods or the rates of interest) matched to the images, thereby assisting the learner's intuitive understanding of the variation in the numerical value.

The calculation process description section 60 gives a detailed description of a calculation process that is presented to the learner by the fund calculation process presentation section 20. The calculation process description section 60 matches functions, constituting the calculation process presented by the fund calculation process presentation section 20, to input numerical values corresponding to the functions, and displays them.

For example, assuming that the story represented by the financial situation presentation section 10 is as shown in FIG. 2, the learner should calculate the deferment interval and the accumulation interval.

In the case where the deferment interval is calculated in accordance with the story, the calculation process description section 60:
gives a description instructing the learner to select the PMT function of the actual financial calculator and then input 50 to the PMT function with regard to the situation where Mr. Gil-dong Hong deposits five hundred thousand won in an accumulative fund at the end of each month,
gives a description instructing the learner to input 20 to the N function with regard to the case where the accumulation period is 20 years,
gives a description instructing the learner to select the I/Y function of the actual financial calculator and then input 12 to the I/Y function with regard to the case where the rate of return of the accumulative fund is 12%, and
gives a description directing the learner to select the future value calculate command CPT and then a function FV₁ for performing a future value calculation with regard to the question “How much money can Mr. Gil-dong Hong receive 25 years later?” presented by the story.

As described above, the calculation process description section 60 kindly displays functions and numerical values substituted for the functions with regard to each of the situations constituting the story, and the learner can sequentially view the story initially presented by the financial situation presentation section 10, the numerical elements included in the story, a calculation process suitable for the story, and a description of the calculation process at a glance. In addition, the learner can view images and a chart corresponding to calculation results using the fund calculation performance result display section 30, and can view not only the intuitive images corresponding to the calculation results but also the detailed amounts of money (or periods or the rates of interest; which will be omitted hereinafter) corresponding to the images, so that the learner can achieve both an intuitive learning effect and a detailed learning effect.

The additional description section 80 is formed to be included in the financial calculator usage presentation section 40, and presents a detailed procedure in which the learner manipulates the actual financial calculator.

When the learner selects functions using the actual financial calculator and substitutes numerical values (the amount of money, a period, the rate of interest, etc.) for the selected functions, desired results may not be obtained only by simply selecting the buttons of the financial calculator in the sequence presented by the fund calculation process presentation section 20. That is, erroneous calculation results may be obtained because numerical values remaining inside the financial calculator affect the subsequent calculations or erroneously calculated values can be obtained due to the selected sequence depending on the function.

Accordingly, the additional description section 80:
presents functions and numerical values that the learner should select in the sequence presented by the fund calculation process presentation section 20, or
presents actions that the learner should take prior to selecting functions.

In the drawing, prior to calculation No. 1 (input of the amount of accumulated money), the item ‘deletion of TVM work sheet values’ and the additional description “deletion of existing [N], [I/Y], [PV], [PMT] and [FV] values from the item” are given. The significance of this is to prevent previous values from affecting new calculations by prompting the learner to delete values obtained or input in previous calculations.

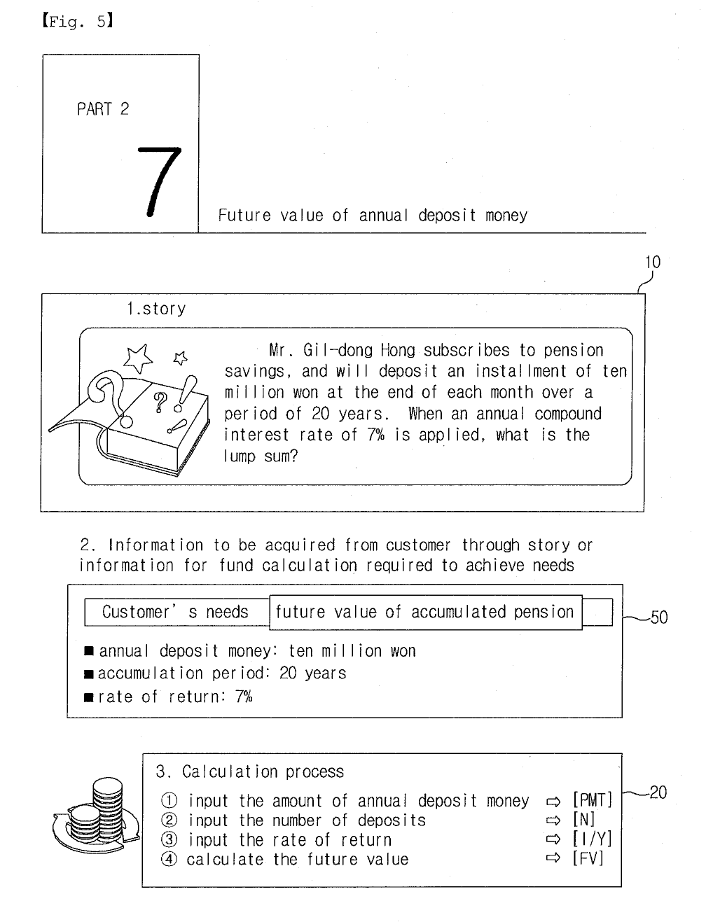

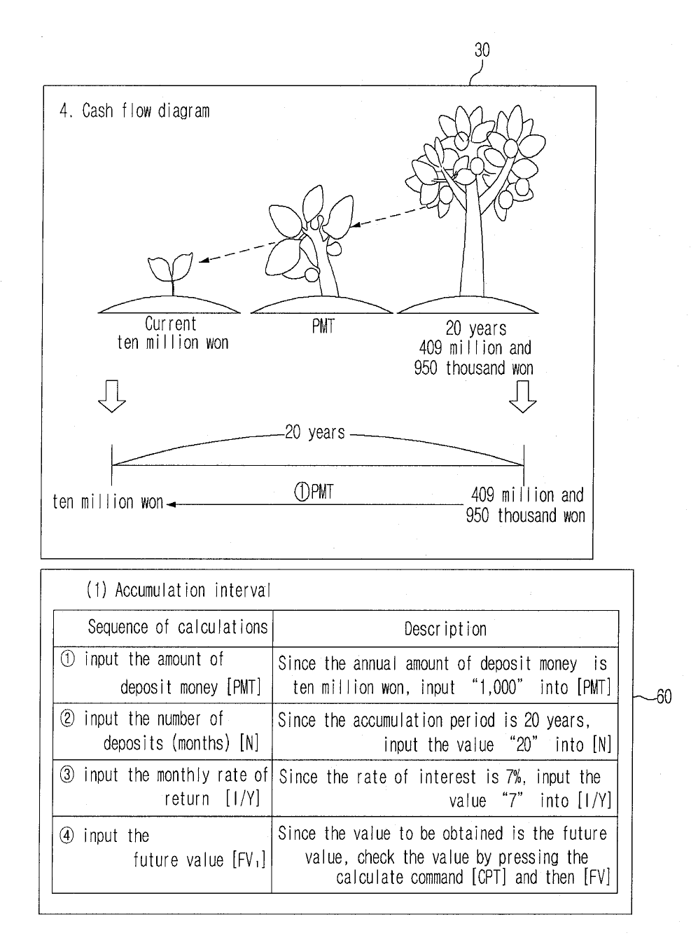

Meanwhile, the financial calculator usage presentation section 40 may present usages for respective modes. The modes include an end mode END and a beginning mode BGN. Depending on the flow of cash, one of the two modes may be selected (in some cases, one of the two modes is selected and a calculation is made). This will be described with reference to FIGS. 5 and 6 together.

FIG. 5 shows examples of calculation methods in end and beginning modes for a single story, and FIG. 6 is an enlarged view of FIG. 5.

In general, when the deposit and withdrawal of funds, that is, the flow of funds, occur at the end of each period, financial calculations are made in end mode.

In contrast, when the flow of funds occurs at the beginning of each period, financial calculations are made in beginning mode. In general, the learner may select one mode from among end mode and beginning mode and make financial calculations. In the case where a specific flow of funds occurs during a specific period as is the case for installment savings, an accumulative fund or a pension, the financial calculator should make financial calculations in beginning mode. When installment savings is taken as an example,

When Mr. John subscribes to one-year installment savings on Mar. 1, 2006 and deposits monthly installments, he should make 12 deposits over a period from Mar. 1, 2006 to Feb. 1, 2007 and then he can receive money one month later. That is, since a monthly installment is deposited at “the beginning of each month,” the learner must change the calculation mode of the financial calculator to beginning mode.

Accordingly, it is preferred that the financial calculator usage presentation section 40 present different calculation sequences and additional descriptions for respective modes (end mode and beginning mode). In FIG. 5, the financial calculator mode display section 90 is added to the financial calculator usage presentation section 40, and displays calculation sequences and additional descriptions for respective modes.

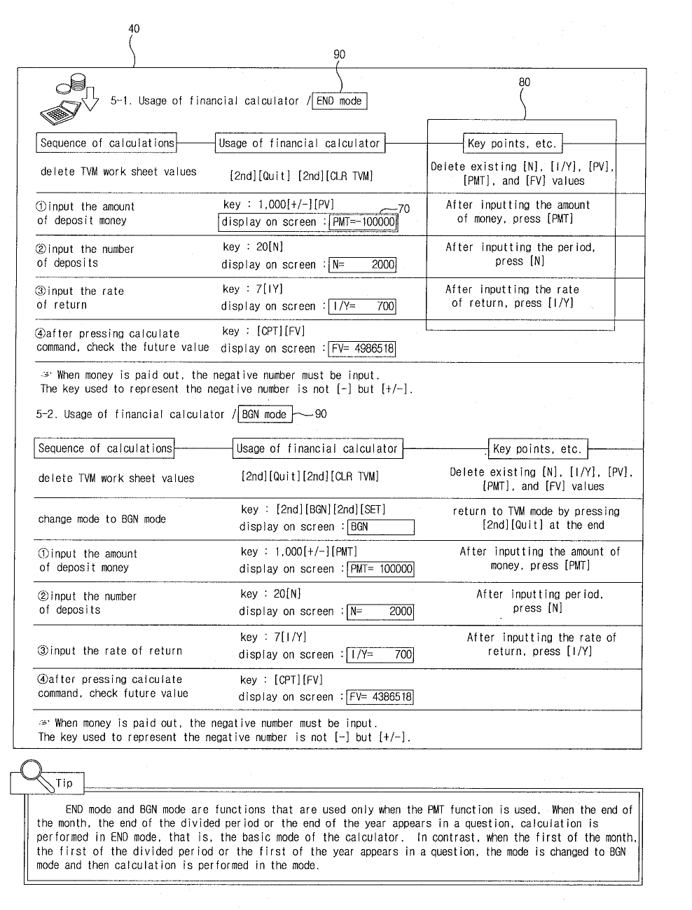

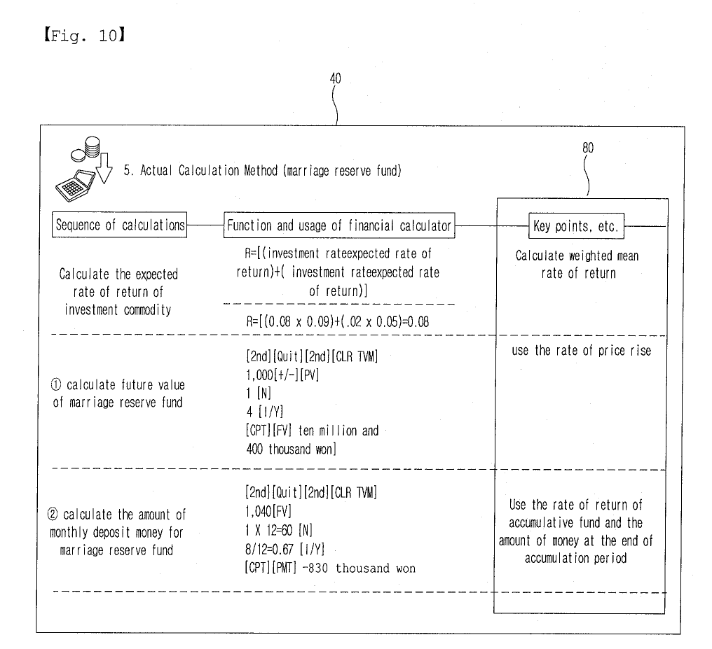

Referring to FIGS. 7 to 14, a composite financial consultation case according to an embodiment of the present invention will now be described. A composite financial consultation case refers to the case where two or more detailed financial consultation topics are included in a single financial situation presentation section 10. Such a composite financial consultation case corresponds to a situation which frequently occurs in actual financial consultations. In order to realistically represent such a situation and maximize educational effects, a financial situation is presented in dialogue form.

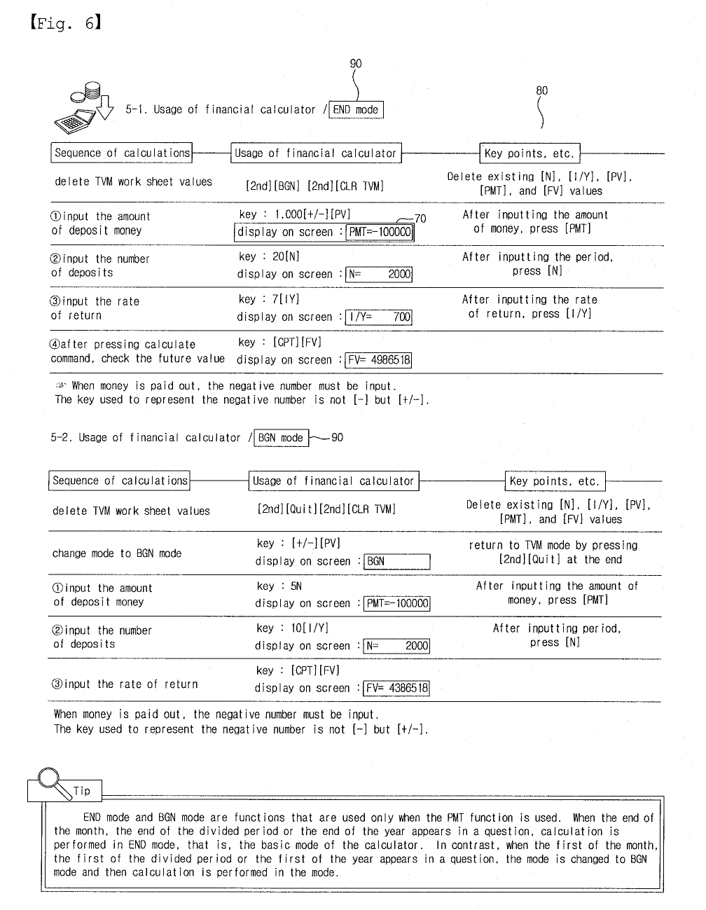

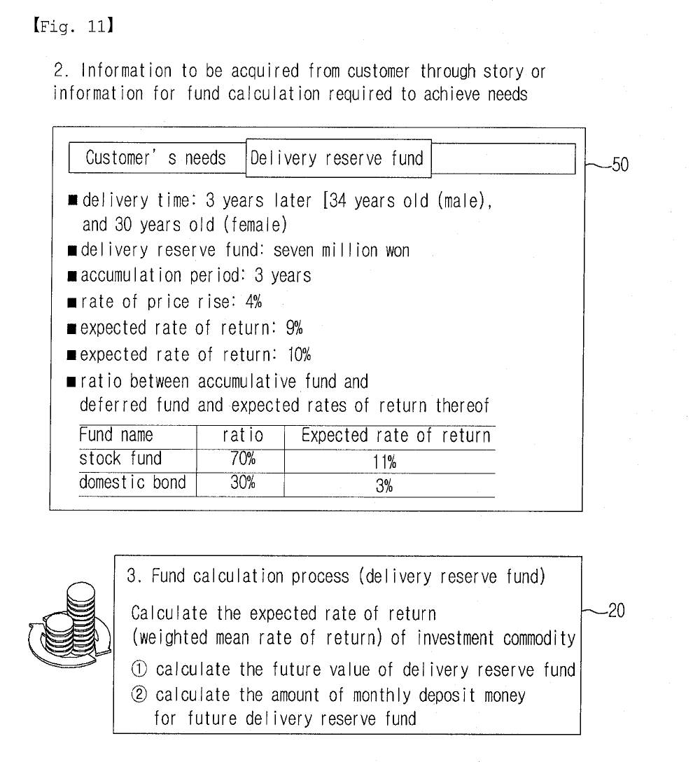

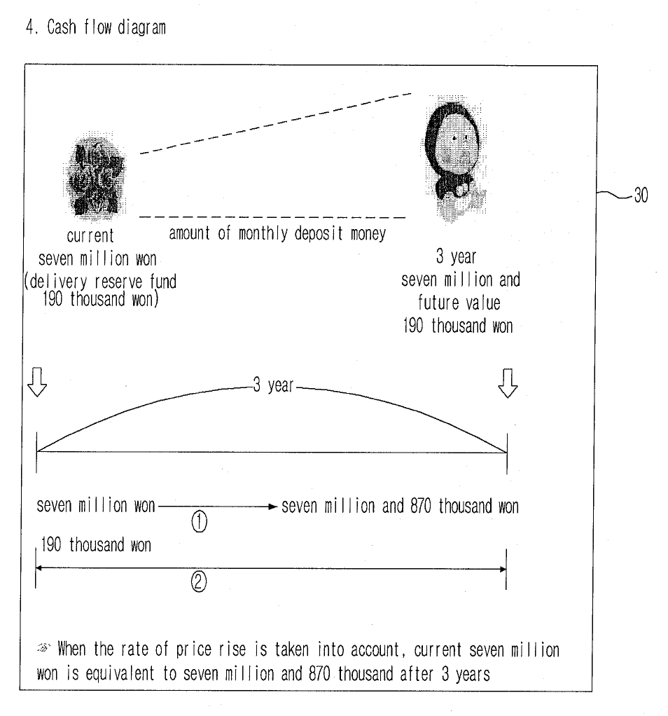

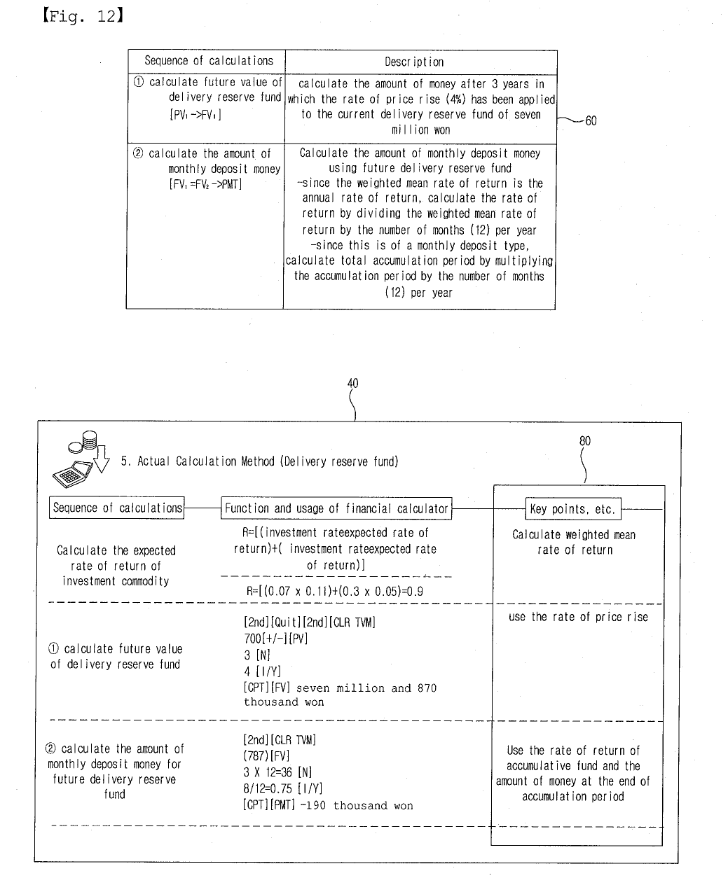

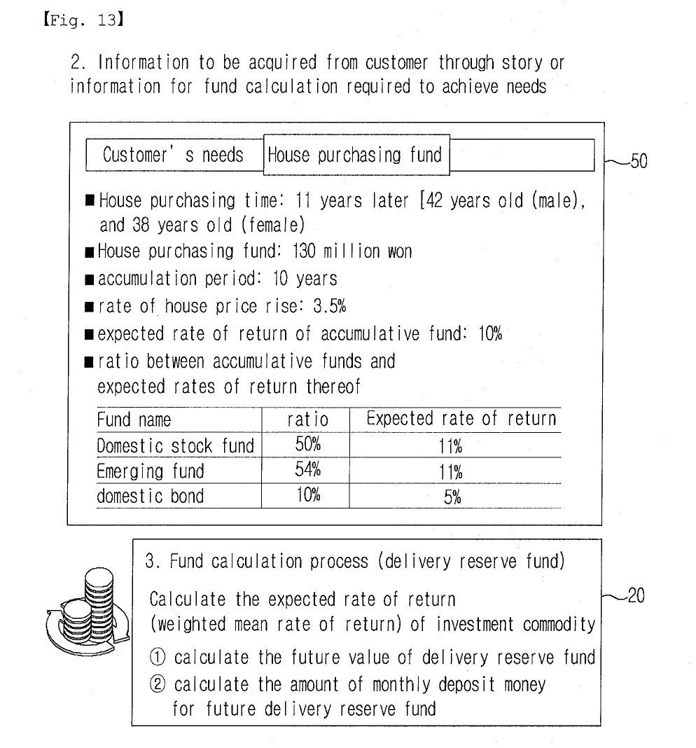

The financial situation presentation section is shown in FIGS. 7 and 8. These drawings show that the spirit of the present invention has been applied to the financial situation presentation section 10 with respect to three respective detailed financial consultation topics. The three financial situations include a marriage reserve fund related to FIGS. 8 to 10, a delivery reserve fund related to FIGS. 11 to 12, and a house purchasing fund related to FIGS. 13 to 14.

The embodiment of the present invention related to the composite financial consultation case includes a single financial situation presentation section 10, and preferably includes, for each detailed financial situation, a fund calculation process presentation section 20, a fund calculation performance result display section 30, a financial calculator usage presentation section 40, a fund calculation numerical element display section 50, and a calculation process description section 60. Meanwhile, it is preferable to apply one or more of the above-described financial calculator result screen display section 70, additional description section 80 and financial calculator mode display section 90 to each detailed financial situation. It can be seen that in this composite consultation case, the additional description section 80 has been used in common among them.

Here, it is preferred that in the financial situation presentation section 10, numerical values related to important fund calculations or portions related to detailed financial purposes be colored with preset colors.

A description of the finance teaching material is now terminated. The financial education simulation method using the finance teaching material will be described below.

FIG. 15 is a conceptual diagram showing a financial education simulation method according to an embodiment of the present invention.

The shown financial education simulation method is configured such that a server 100 provides a Time Value of Money (Time Value of Money) calculator interface to a user terminal 10 connected over a network, the user terminal 10 selects a story to learn, and the server 100 returns appropriate result values when the user terminal 10 presses the buttons of the financial calculator in accordance with the story. At this time, the server 100 provides a cash flow diagram to the user terminal so that the learner himself or herself who operates the user terminal can easily and rapidly understand his or her calculation results. A cash flow diagram is a chart in which the relationship between the area sizes of a current fund and a future fund is represented in a 1:1 scale, and embodies the size of a current fund and the size of a future fund generated by the current fund using an area chart. In this case, although in the drawing, a fifty million won rectangle and a one hundred million won rectangle are used, it is apparent that figures other than rectangles may be used. The other figures include 1) figures symbolizing growth, such as trees, 2) figures corresponding to a specific financial purpose, for example, college expenses, educational insurance or house purchasing expenses, such as bachelors' hats, children or houses, 3) figures directly representing financial affairs, such as bills or currencies, and figures set by the user computer 10 or the server 100.

Here, a preset period is interposed between the figures, and the figures may vary in size or color. In this case, it is preferred that the variation in size be configured such that the areas of the figures are consistent with the results of financial calculations. For example, it is preferred that the size of a one hundred million won rectangle be exactly twice that of a fifty million won rectangle or the height or width of the one hundred million won rectangle is accurately twice that of the fifty million won rectangle (the former is more preferable). The server 10 receives the result values of financial calculations, sets the accurate scales of enlargement of a figure based on the result values of financial calculation, and determines the sizes of the figure. Since the determination of the sizes may be implemented by software developers using various methods, such as the adjustment of the resolution of the figures, the method of determining the sizes is not described in greater detail in the specification. If the figures varying in size depending on the accurate results values of financial calculations are included in a cash flow diagram, the cash flow diagram assists a learner who first encounters the financial calculations to immediately determine the calculation results. The above-described cash flow diagram was devised by the present applicant and has the purpose of improving the learner's intuition and increasing educational effects.

In the drawing, the cash flow diagram shows that, with respect for:

current fund: fifty million won,
expected future fund: one hundred million won, and
rate of interest: 12%, a period of three years is taken. In this case, the ratio of the area of the current fund of fifty million won to that of one hundred million won is 1:2.

Here, the story describes the case of any one of a pension, a loan, the rate of periodic return, a retirement plan, a target fund, a guaranteed fund and a retirement fund. However, this is an example, and it is apparent that the spirit of the present invention is not limited thereto. The story is configured in a form including text, images or a moving image so that the learner who connects to the server 100 through the user terminal can encounter a case which may occur in actual life. Although in the present invention, a story configured in the form of text is chiefly described for ease of understanding and description, it is apparent that the present invention is not limited thereto. It is noted that a story may be implemented in the form of flash animation in addition to the form including text, images or a moving image.

Meanwhile, the story provided by the server 100 to the user terminal is configured in the form in which a current fund, a future fund, the rate of interest, a period and other conditions have been fixed. Accordingly, the user terminal 10 should select the number and function buttons of the financial calculator in consistency with the story presented by the server 100. If the user terminal 10 uses a number or a function which is not consistent with the conditions presented by the server 100, the server 100 detects the erroneously used number or function and notifies the user terminal 10 of this.

That is, equations for obtaining desired result values are matched to the story, and field values for calculating the equations are acquired from the story. Here, in the case where the model or type of the financial calculator has been fixed, key values to be input to the fixed financial calculator and/or the sequence of input of the key values can be determined based on the story or the field values included in the story (the user computer 10 may select/input them). The server 100 stores the sequence of key values to be pressed for a specific story and a specific financial calculator model. Here, the stored key values include 1) buttons to be pressed and the sequence of pressing the buttons, exclusive of numerical information, and 2) the information of 1) plus numerical information. The case of 1) has a problem in that an error cannot be detected in the case where a user erroneously presses a number included in a story or another variable value is input at the time when a specific variable value should be input. Since the case of 2) stores all button values to be pressed in the financial calculator, including all numbers included in the story, the case of 2) can overcome the problem which may occurs in the case of 1). Meanwhile, in this case, the story provided by the server 100 includes variable values, and an interface for adjusting/inputting variable values, such as selection boxes, is provided. When one or more variable values are adjusted/input by the user computer 10, a case where number values to be pressed are changed due to the input variable values. That is, the variable values are changed in the story. In this case, the server 100 receives the changed variable values, and key values to be input are stored as changed variable values. For this purpose, when information to be input is stored, 1) information about buttons to be pressed, exclusive of numerical values, as fixed value information, 2) information about buttons to be pressed, which is created by considering input numerical values, and 3) information about the sequence of buttons to be pressed in the cases of 1) and 2) should have been included.

Accordingly, the sequence of buttons to be pressed is determined by the information of 1) to 3).

After the server 100 has provided the specific story to the user terminal, the server 100 obtains and analyzes the button input information input by the user through the interface of the fixed calculator model of the user terminal 10. In order to obtain desired result values, the server 100 compares specific buttons (number or function buttons) to be pressed and/or the sequence of the specific buttons to be pressed with the button input information obtained from the user terminal 10. In this case, if, as a result of the comparison, one of the various types of buttons of the user's calculator has been erroneously pressed or the sequence of pressing buttons has been erroneous, the server 100 may 1) send a preset message, such as a message providing notification of erroneous pressing, to the user, 2) send a message providing notification of a solution, such as a message providing notification of which buttons are the correct buttons, 3) make the user terminal 10 wait for a preset time until correct button values are input, 4) provide a preset display, such as the flickering of the button regions of the calculator interface which correspond to the correct button values and appear in the user terminal 10, 5) send a simulation screen showing the sequential pressing of the correct buttons, 6) may send information, capable of emphasizing buttons (causing buttons to flicker, or showing contour lines in a preset color at the edges of buttons) at specific times, to the user computer 10 in order to achieve the simulation effect in which correct buttons are sequentially pressed, and 7) may send a simulation screen, showing the overall sequence of pressing buttons in order to obtain desired result values, to the user computer 10. It will be apparent that information about the sequence of buttons to be pressed in order to obtain desired result values in accordance with a specific story stored in the server 10 must be provided for each model or type of financial calculator, the calculator interface to be provided to the user computer 10 must be managed for each model or type of financial calculator, and the user's button input information sent by the user computer 10 must be processed based on the calculator interface provided to the user computer 10.

Here, a program in the Javascript language may be embedded in the webpage of a screen which is send by the server 100 and is displayed on the user computer 10. The Javascript program may include various types of control functions processed by the server 100, and may acquire various types of events occurring in the user computer 10. The events may include information about buttons pressed in the calculator interface of the user computer 10. The program in Javascript may obtain button events occurring in the calculator interface of the user computer 10, compare the button events with the included control functions, and then determine whether the user has pressed the correct buttons in the correct sequence. The control functions include information about control criteria such as equations corresponding to a specific story and the types and sequence of buttons to be pressed in accordance with the specific story and/or a specific calculator interface, and a function of determining whether the obtained events meet the control criteria. It is apparent that the functions performed by the program in Javascript correspond to the processing of information that is obtained from the user computer 10 by the server 100 over a wired/wireless network and input by the user. Meanwhile, the program in Javascript may be responsible for part of the control functions performed by the server 100.

In the case where event information related to the user's calculator interface and obtained from the user computer 10 is erroneous, the server 100 may output information about the error to the monitor of the user terminal in the form of a message, images or a moving image or issue a sound indicative of the occurrence of the error, so that the learner who operates the user terminal 10 can become aware of the occurrence of the error.

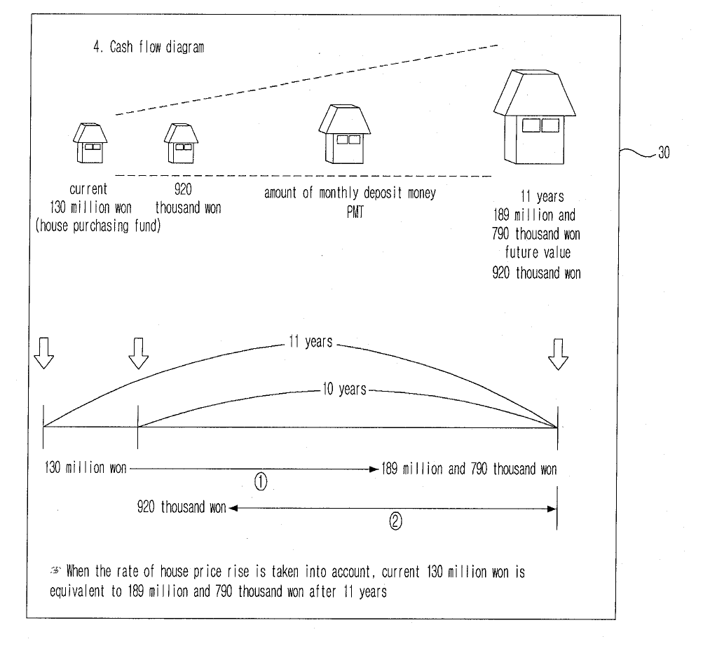

FIG. 16 is a conceptual diagram showing a financial education simulation method according to another embodiment of the present invention.

The shown embodiment was devised for persons who cannot use the financial calculator at all. In the present embodiment, a server 100 presents a story to a user terminal, a user on a user terminal side provides data for the calculations of a desired amount of money, a desired period and a desired rate of interest and other financial calculations to the server 100, and after the user has obtained desired result values, the server converts the desired result values into a cash flow diagram and provides the cash flow diagram to the user terminal, for the user who is poor at financial calculations. In the drawing, the story selected by the user terminal 10 read:

“Mr. Gil-dong Hong subscribes to pension savings, and will deposit a installment of [ ] thousand won at the end of each month over a period of [ ] years. When an annual compound interest rate of 7% is applied, a lump sum will [ ] won,” and the user terminal 10 can receive desired financial calculation results by entering numbers in blanks. In the story shown in the drawing,
for learners who want to learn financial calculation, portions are not left blank, as illustrated in the embodiment of FIG. 15,
whereas, for users who do not want financial calculation itself and want only desired financial calculation values, portions in which the amounts of money are entered are left blank in order to allow the users to enter desired values and receive result values therefor.

From the illustrated cash flow diagram of the present embodiment, it can be seen that the areas for a current fund, a user's desired future fund and a period are left blank. This is because the fund and period areas are left blank in the story provided by the server 100 of the present embodiment to the user terminal 10. When data about the funds and the period is entered through the user terminal 10, appropriate result values are presented. Here, when the final value of the future fund indicated on the right side of a cash flow diagram and configured in the form of a rectangular chart is determined by data provided by the user terminal 10, the area of the future fund is varied by the server 100 in accordance with the final value. If the current fund is one thousand won and the user's desired future fund is three thousand won, the shown cash flow diagram indicates a period taken until the future fund reaches three thousand won and, simultaneously, the rectangular area of the future fund is scaled up to a size three times that of the current fund.

In a story, 1) equation functions configured to obtain desired result values, and 2) various types of variables to be included in the equation functions have been previously determined. For example, in the story provided in FIG. 2, the amount of money in a lump sum is the result value. An equation function for calculating the result value is f=(number of years, rate of interest, monthly amount of deposit money). The number of years is a field value that is entered in the blank of “over [ ] years.” An annual compound interest rate of 7% is the rate of interest. If [ ] thousand won is deposited each month, the amount of deposited money is a field value for the field “amount of money.” It is apparent that in the case of a special situation in which a compound interest rate is not applied, an equation function corresponding to the situation is matched to the story in which the situation is included. As described above, a single story includes various field values, and an equation function for obtaining a single desired result value is determined in association with a single story. Therefore, when the server 100 receives specific values for the field values from the user terminal 10, the server 100 creates a desired result value by substituting the field values for the equation function. Meanwhile, it is apparent that if the required time is a desired result value, an equation function for calculating the time exists and various types of variables for calculating the equation function can be received from the field values.

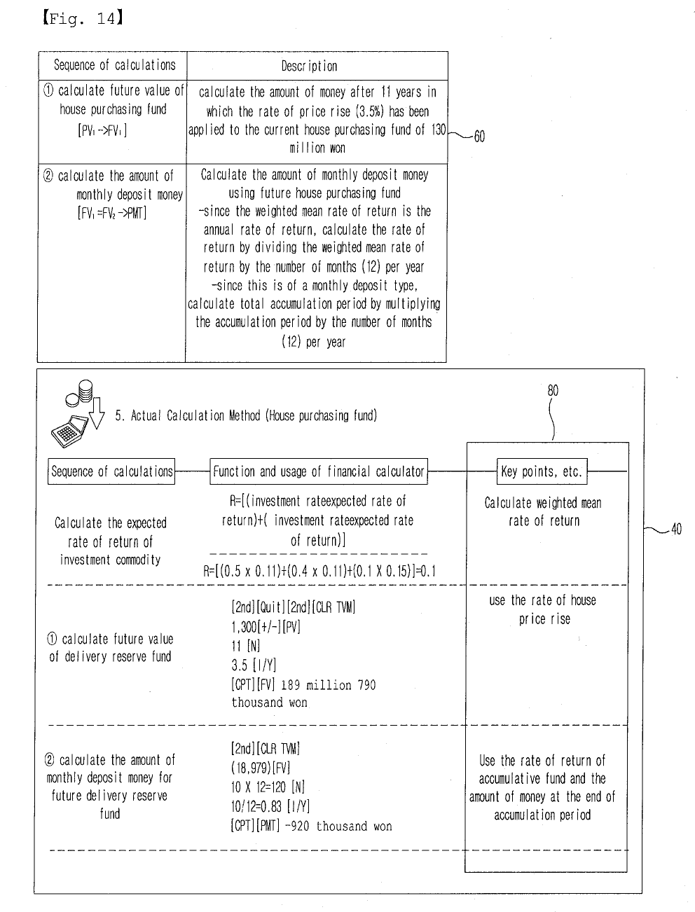

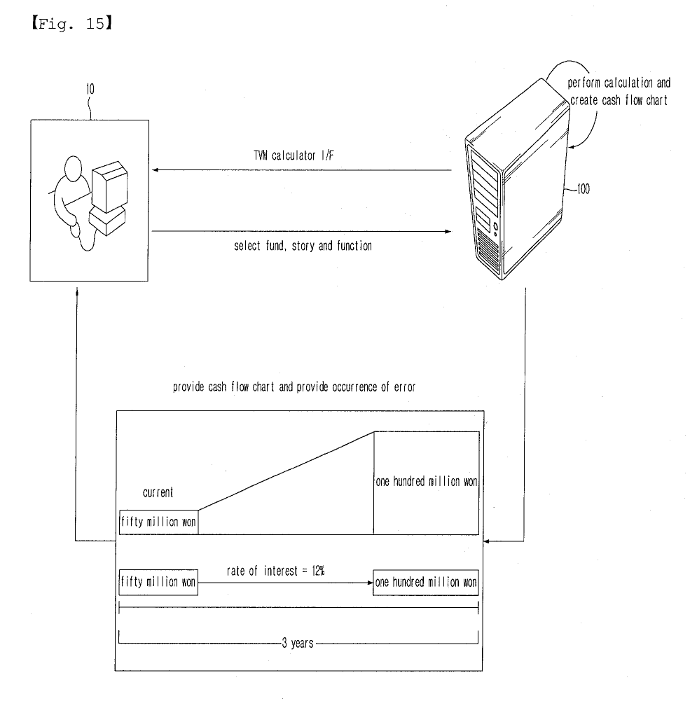

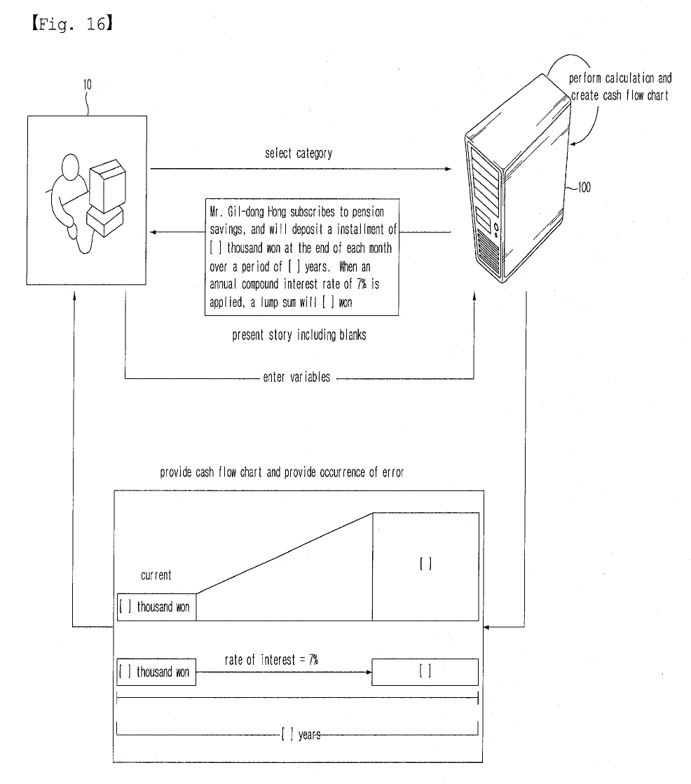

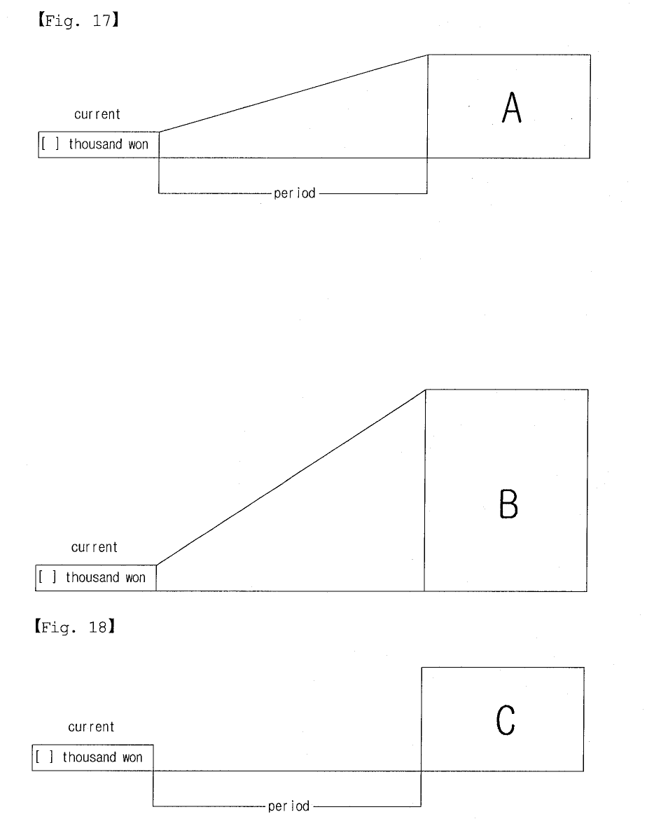

FIGS. 17 to 19 schematically illustrate the cash flow diagram processing method of the financial education simulation method according to the present invention.

First, referring to FIG. 17, on the assumption that the value of a future fund is “A” with respect to a current fund of [0] thousand won and the relationship between the current fund and the future fund is a 1:1 linear relationship, when the value of the current fund is doubled, the value of the future fund is “B,” which is twice “A.”

FIG. 18 shows an area that was expanded not only in a vertical direction but was also expanded in a lateral direction. Here, the area of “C” is identical to that of “B” shown in FIG. 17.

FIG. 19 shows a cash flow diagram applied to the case where two variables for the current fund are input through the user terminal 10, that is, the user wants to compare result values with each other by inputting two values of the current fund. In this drawing, the areas “D” and “E” of the future fund are shown on a single cash flow diagram, and the variation in the future fund is represented in the direction of an arrow. Through this, the server 100 can present user or learner desired comparative variation, and the user or learner can be intuitively aware of the value of the future fund varying depending on a changed condition. Here, it is apparent that if the number of comparative values desired by the user is two or more, the user can view these values at a glance.

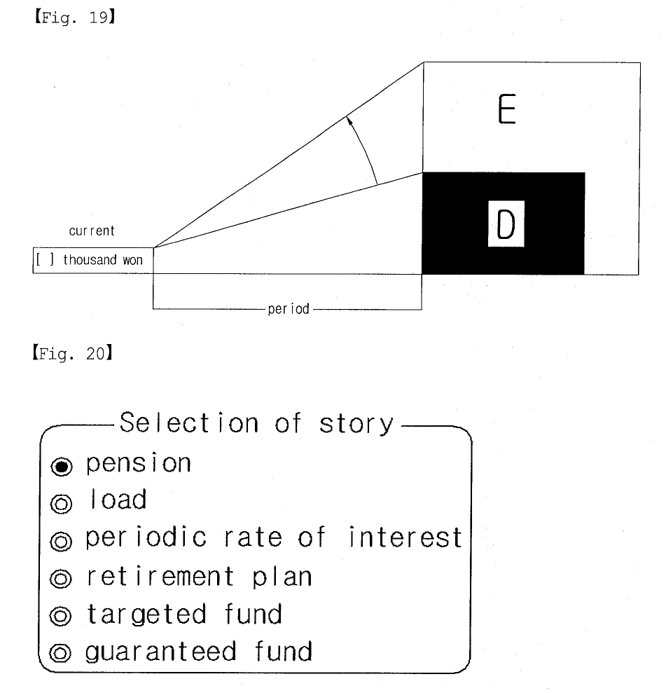

FIG. 20 shows an example of a story list that the server 100 presents to the user terminal.

Generally, a learner who wants to learn a financial calculator or a learner who does not know the usage of the financial calculator at all but requires assistance for his or her financial design can select a field for learning or reference using the story list provided by the server 100. The drawing shows a list of a pension, a loan, the periodic rate of return, a retirement plan, a targeted fund and a guaranteed fund, and indicates that a pension item has been selected through the user terminal 10. It is apparent that other items related to financial affairs can be added to the shown story list. When a learner (or a user, which will be omitted hereinafter) selects a specific item (in the drawing, a pension item) from the story list, the server 100 provides cases corresponding to the story selected through the user terminal 10 to the user terminal 10, and the user terminal 10 can select any story from among the provided stories and perform financial calculations.

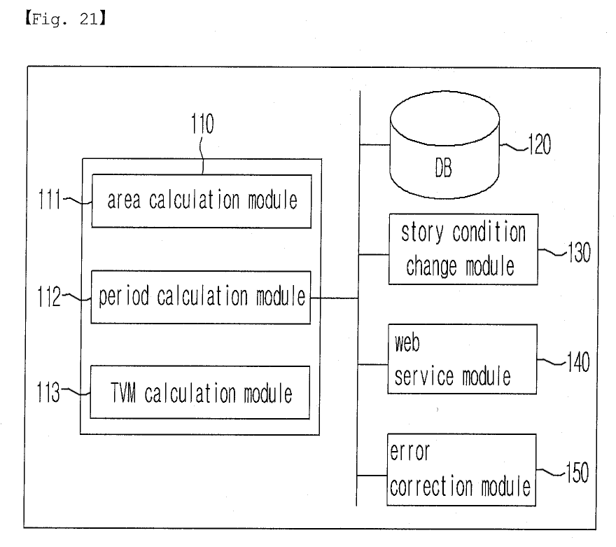

FIG. 21 is a schematic block diagram of a server 100 according to an embodiment of the present invention.

The shown server 100 includes a cash flow diagram processing module 110, a database 120, a story condition change module 130, a web service module 140, and an error correction module 150.

The web service module 140 provides the main page of a website to the user terminal 10 connected over a network, provides a story list (see FIG. 20) to the user terminal 10, and, when a story item is selected through the user terminal 10, provides a plurality of stories in the form of a sub-menu added to the story item. Furthermore, the web service module 140 provides an interface for the use of the financial calculator. The interface shows a financial calculator (TVM calculator) menu, a story and a cash flow diagram, and describes the usage of the financial calculator to a learner who wants to learn the usage of the financial calculator through the server 100 in the form of a moving image, a flash animation, text and images. It is apparent that it is preferred that the values of the usage of the financial calculator to be described through the interface vary depending on conditions (a current fund, a period, the rate of interest, a future fund, etc.) set in the story.

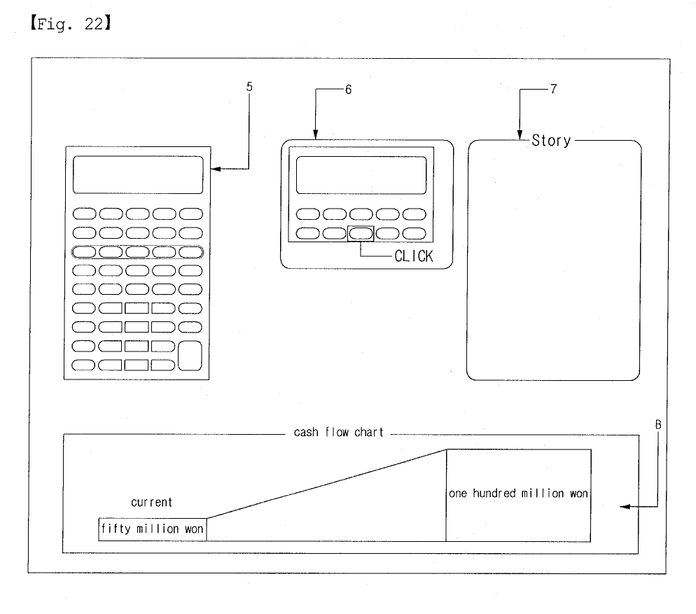

Here, the financial calculator menu may include number buttons, function buttons and the other function key buttons of the financial calculator. The interface provided by the web service module 140 will be described with reference to FIG. 22.

FIG. 22 shows an example of an interface provided by the web service module 140.

The shown interface is provided with a financial calculator menu 5, a training menu 6, a story list 7 and a cash flow diagram 8. The financial calculator menu 5 is provided with number buttons and function buttons (PMT, N, I/Y, FV, etc.), which are provided on a typical financial calculator. The interface is operated in the same manner as the buttons of the financial calculator are pressed in response to input through a mouse or keyboard. The training menu 6 sequentially presents required buttons of the calculator buttons to be pressed in accordance with the story. The learner can learn usage suitable for the story through the training menu 6. A webpage provided by the web service module 140 may show all results to which the spirit of the present invention has been applied on a single web screen, may show a stepwise result based on preset criteria, or may show results on two or more tab screens. The server 10 may provide a webpage through interaction with the user computer 10 (in response to a specific input when the input is received from the user computer 10). In this case, it is more preferable that the web page be created to support an asynchronous communication method such as AJAX. That is, it is preferred that when the user erroneously presses a specific button or changes a specific variable value, the overall webpage is not updated and only a necessary part of the webpage is updated.

The story list 7 presents various types of items required for the calculation of a desired financial target fund, such as a pension, a loan, the periodic rate of return, a retirement plan, a targeted fund or a guaranteed fund, to the user terminal 10, and presents a sub-menu for an item selected through the user terminal 10 or a plurality of stories for the selected item to the user terminal 10. The cash flow chart 8 shows result values, calculated based on conditions selected by the learner or user, in the form of images selected by the user, images selected by the server 100, or images and an area chart consistent with a financial purpose selected by the user.

When the user of the user terminal connected to the server 100 is not a learner but a general user, the story condition change module 130 receives data entered in the blanks (see FIG. 16) of the story item and story selected by the user, determines the validity of the input data, and provides the input data to the cash flow diagram processing module 110. In this case, the general user may additionally select and view one or more actual consultation cases similar to the financial item selected by the user, and may also select and view financial calculation result values and statistical data related to the consultation cases.

The cash flow diagram processing module 110 calculates result values while referring to the story selected through the user terminal 10 and numbers and functions selected based on the selected story through the user terminal 10, creates an area chart corresponding to the calculated result value, and provides the area chart to the user terminal 10.

Preferably, the cash flow diagram processing module 110 includes an area calculation module 111, a period calculation module 112, and a TVM calculation module 114.

The area calculation module 111 calculates the area of a chart based on a final value calculated based on numbers (funds) and functions input through the user terminal 10. The calculated area is calculated based on an initial value (a current fund) input through the user terminal 10, as shown in FIGS. 17 to 19. If the size of the initial value (the current fund) is 1 and the size of the final value (the future fund) is 3, the area calculation module 111 sets the area of the initial value to 1, sets the area of the final value to 3, and sets an area chart corresponding to the final value in a lengthwise direction (see reference character “B” in FIG. 3) while considering the lateral direction of the cash flow diagram, that is, the period, or in the lateral and vertical directions, as shown in FIG. 4. Here, the area calculation module 111 has coordinate values for the area chart corresponding to the final value, and draws a rectangular area chart on a webpage using the coordinate values.

When the user or the learner selects a story for the calculation of a period, the period calculation module 112 calculates a period corresponding to the story. For example, when the user selects a story in which the current fund of the user is one hundred million won, the target future fund of the user is three hundred million won and the rate of interest of a financial institution is a compound interest rate of 3%, the period calculation module 112 calculates a period suitable for conditions given by the user and incorporates this period in the cash flowchart. If the period calculated by the period calculation module 112 is long, the distance between the current fund and the future fund on the area chart is long. Otherwise, the distance is short.

The TVM calculation module 113 acquires data input by the user in the story selected by the user, substitutes the data for a previously prepared equation for each story included in the story list, and returns a result value in the form of a cash flow diagram.

Meanwhile, the functions of the server 100 described in conjunction with FIG. 21 may be implemented in the form of a program that is installed and runs in the user terminal 10. In this case, the web service module 140 provides the program to the user terminal 10, and the user terminal 10 downloads and uses the program. Here, the program installed in the user terminal 10 may be implemented to perform the processes of:
displaying a story for a financial situation on a monitor,
displaying a financial calculator menu, including buttons for inputting numbers and function values on a monitor, and
displaying on the monitor a cash flow diagram which represents the variation in the fund and a function selected from the financial calculator menu by the user in an area graph. For this purpose, data about a story for each financial situation must be provided to the user terminal 10.

This is solved using any one of the following two methods:

1) a method in which the server 100 provides a story list and respective stories corresponding to the story list to the user terminal 10 in the form of data files and the user terminal 10 displays them on the monitor

2) a method in which whenever the user terminal 10 connected over a network requests a story list, the server 100 provides a corresponding story to the user terminal 10 and the user terminal 10 displays the story on the monitor

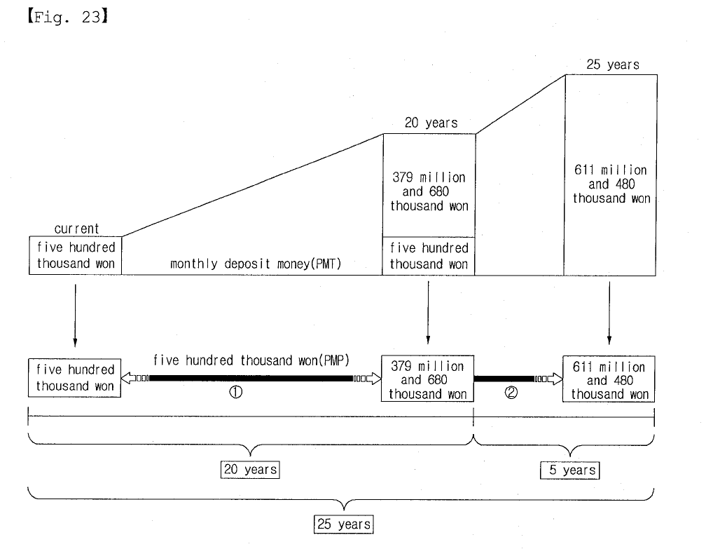

FIG. 23 shows an example in which a cash flow diagram according to the present invention is represented based on the story.

First, the story shown in FIG. 23 reads:

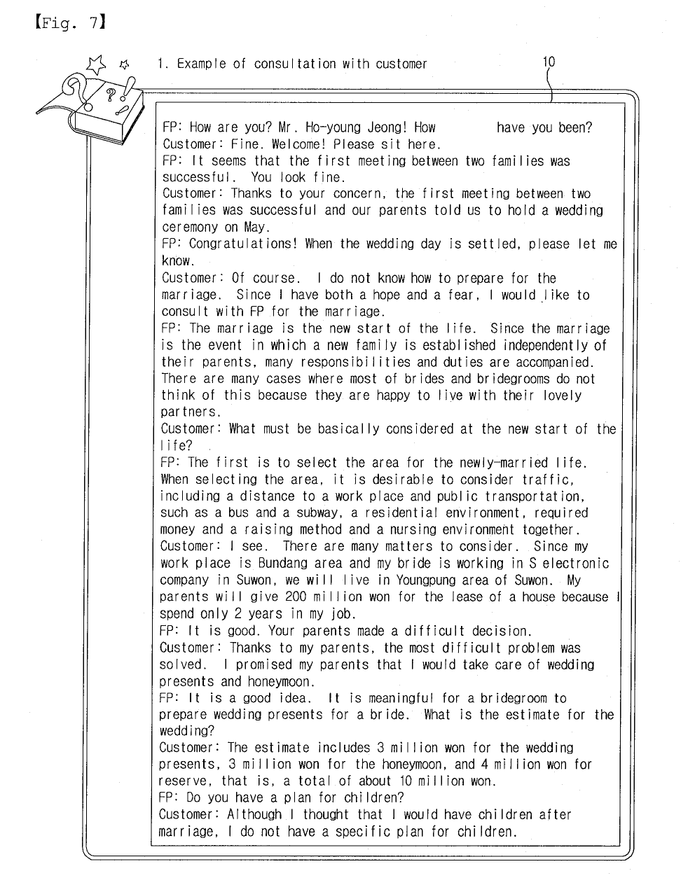

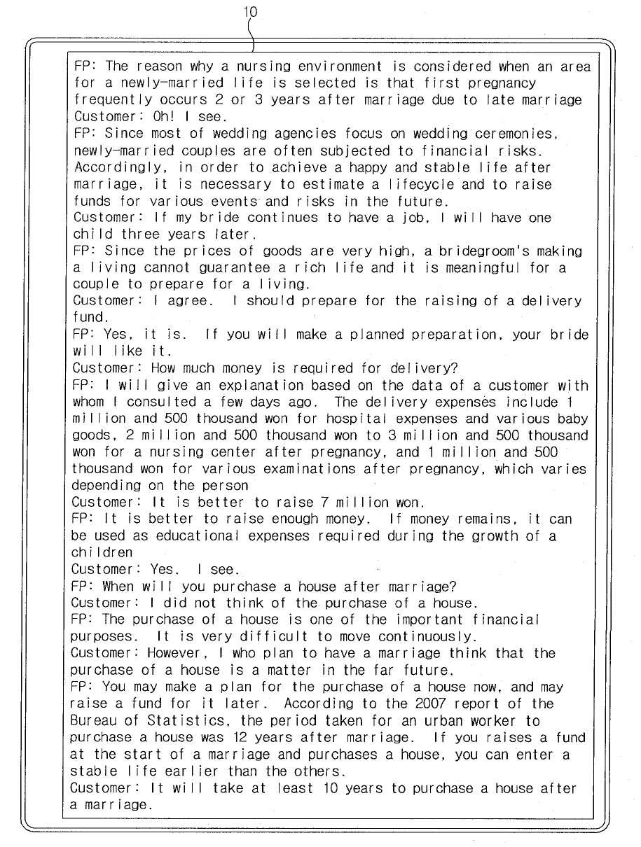

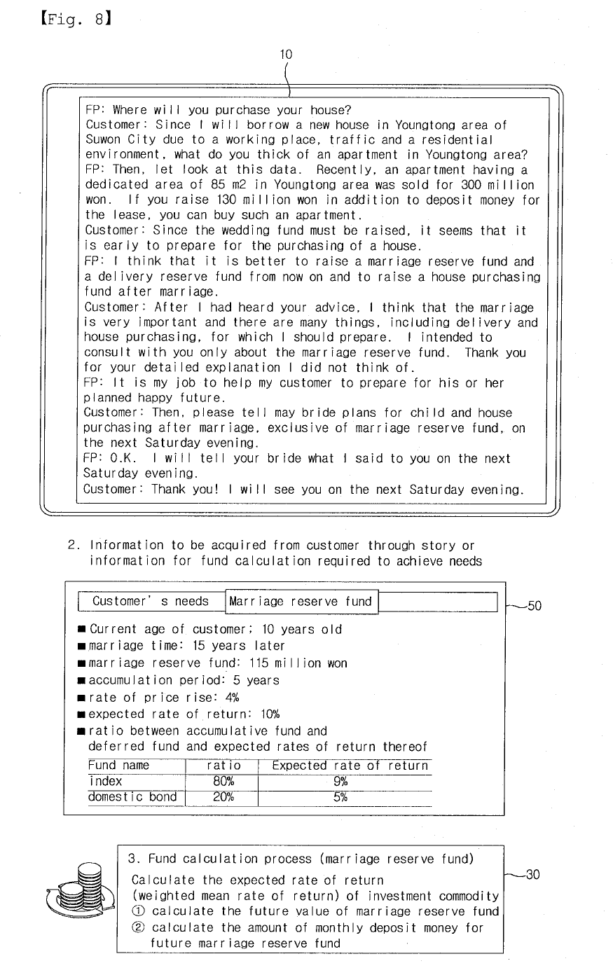

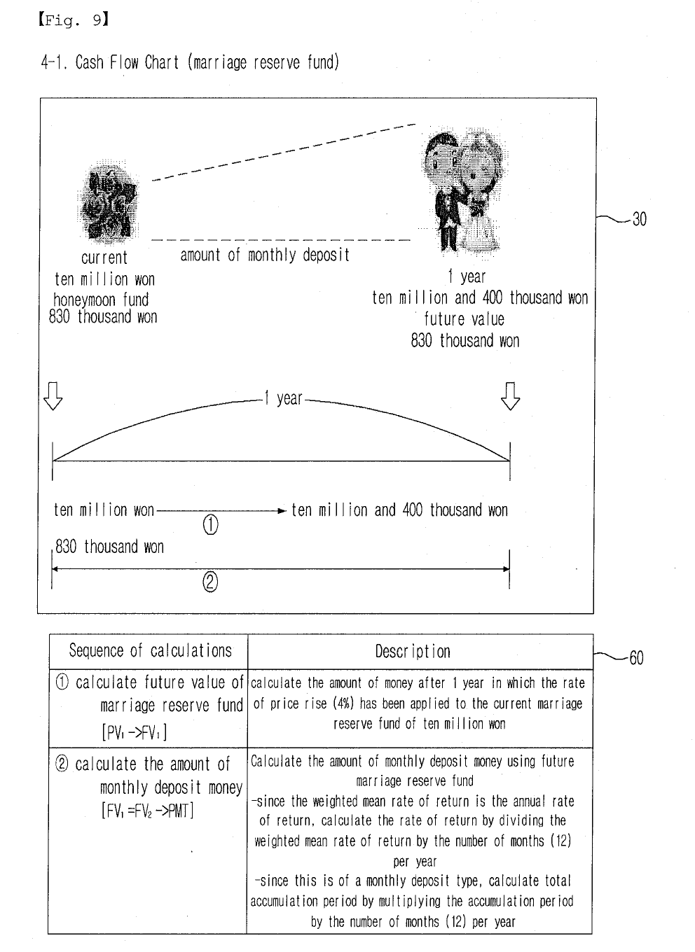

“Mr. Gil-dong Hong will subscribe to an accumulative fund, deposit five hundred thousand won at the end of each month over a period of 20 years, and be subjected to a five-year deferred period. When the expected rate of return in the accumulation period is an annual compound interest rate of 12% and the rate of return in the deferred period is an annual compound interest rate of 12%, how much money can Mr. Gil-dong Hong receive 25 years later?” This story may be used when the user obtains the future value of the deposit money that occurs after the user has deposited money over a specific period (20 years). In this case, when the user changes the deferred period or accumulation period, the user can immediately check the changed result values. If it is assumed that a story related to the cash flow diagram shown in FIG. 9 is applied to a learner who wants to learn the usage of the financial calculator, the learner selects buttons shown in the financial calculator menu 5 in accordance with the following Table 1 and perform input for the accumulation interval.

TABLE 1

| Sequence of calculations | Description |
|---|---|
| \textcircled{1} input the amount of deposit | Since the monthly amount of |
| money [PMT] | deposit money is five hundred |
| | thousand won, input “50” into |
| | [PMT] |
| \textcircled{2} input the number of deposits | Since the accumulation period |
| (months) [N] | is 20 years, input the value |
| | “20 × 12 =” into [N] |
| \textcircled{3} input the monthly rate of | Since the rate of interest is |
| return [I/Y] | 12%, input the value |
| | “12 × 12 =” into [I/Y] |
| \textcircled{4} input the future value [FV₁] | Since the value to be obtained |
| | is the future value, press the |
| | calculate command [CPT] and |
| | then check the value by |
| | pressing [FV₁] |

TABLE 2

| Sequence of calculations | Description |
|---|---|
| \textcircled{5} input the deferred lump sum | Since the deferred lump sum is |
| [FV₁] = [PV₂] | equal to the future value [FV₁] |
| | of the amount of deposit money, |
| | input [FV₁] into [PV₂] |
| \textcircled{6} input the deferred period [N] | Since the deferred period is 5 |
| | years, input the value “5” into |
| | [N] |
| \textcircled{7} input the rate of return [I/Y] | Since the rate of interest is |
| | 12%, input “12” into [I/Y] |
| \textcircled{8} calculate the required fund | Since the value to be obtained |
| (future value) [FV₂] | is the future value, press the |
| | calculate command [CPT] and |
| | then check the value by |
| | pressing [FV₂] |

When the learner presses buttons shown in the financial calculator menu 5 and inputs numbers and functions PMT, N, I/Y, FV and PV in the sequence shown in Tables 1 and 2, a cash flow diagram such as that shown in FIG. 9 is obtained. If an error occurs in a number input by the learner or a function selected by the learner, errors occur in a period and a final value described in the cash flow diagram, and the error correction module 150 provides notification of the occurrence of the errors to the learner in the form of text, an image and a moving image and requests the learner to input it again.

In this case, the server 100 may further include the step of presenting variable values, that is, information for various types of fund calculations that is required by the financial calculation for the story of FIG. 23.

The variable values may be as follows:

monthly deposit money: five hundred thousand won
accmulation period: 20 years
deferred period: 5 years
expected rate of interest in the accumulation period: an annual compound interest rate of 12%
rate of interest in the deferred period: an annual compound interest rate of 12%
time when money can be received: 25 years later

Meanwhile, the server 100 may create one or more screens selected from among independent screens displayed on the screen of the user computer in the form of pdf files or some other preset type of files. These independent screens may show 1) a story, 2) variable value information for financial calculation, 3) a fund calculation process (the fund calculation process may be stored for each story in the server 100), 4) a cash flow diagram, 5) the sequence and description of the calculations, and 6) the usage of the financial calculator usage.

Meanwhile, it is apparent that the spirit of the present invention may be positively used for financial consultation. In the case of financial consultation, the user computer 10 may be considered to be the user computer of a financial consultant. The consultant interviews a financial consultee, listens to the content of the consultation desired by the financial consultee, and requests the most suitable story for the financial consultee from the server 100. The server 100 sends a specific story to the computer of the financial consultant, blanks [ ] are included in various types of fields that constitute the story, and the consultant receives specific values from the financial consultee, and, when all values have been received, sends the values to the the server 100. In this case, the server 100 obtains desired result values by solving a preset equation corresponding to the preset story using the received field values, and sends the result values to the computer 10 of the consultant. In this case, the server 100 may send a cash flow chart (a diagram), such as that shown in any one of FIGS. 17 to 19 and 23, together with or independently of the result value to the computer 10 of the consultant. In this case, the server 100 may show a simulation in which the result value desired by the financial consultee is created using a specific model or type of financial calculator. That is, the server 100 may provide a specific financial calculator interface to the computer 10 of the user, and may send information about buttons to be pressed at a specific point in time and the sequence of pressing the buttons and information about calculation values output onto the screen of the financial calculator when the buttons are pressed at the computer 10 of the user so that the financial consultee can understand the steps used to create the result values based on the received field values. Here, as described above, in a consultation situation, the control function of the server 100 may be performed by a program in Javascript. Meanwhile, as described above, in a consultation situation, the spirit of the present invention may be implemented by a program installed in the computer 10 of the consultant without requiring the use of the server 100.

1. Financial calculator teaching material for teaching usage of a financial calculator, comprising:
a financial situation presentation section provided in story form;
a fund calculation process presentation section for presenting a fund calculation procedure, including one or more calculation processes, in order to enable fund calculation to be performed for a financial situation presented by the financial situation presentation section;
a fund calculation performance result display section for providing result values of the fund calculation for the financial situation in image form and/or in chart form; and
a financial calculator usage presentation section for providing usage of a preset type of financial calculator in order to enable fund calculation to be performed for the financial situation.

2. The financial calculator teaching material as set forth in claim 1, further comprising a fund calculation numerical element display section for displaying numerical information which belongs to information included in the story and which is required for performing the fund calculation.

3. The financial calculator teaching material as set forth in claim 2, further comprising a calculation process description section corresponding to the fund calculation process presentation section, the calculation process description section further comprising a description of each of the calculation processes,
wherein the description is formed of numerical values included in the fund calculation numerical element display section.

4. The financial calculator teaching material as set forth in claim 1, wherein the fund calculation performance result display section further comprises two or more images formed of preset subject images.

5. The financial calculator teaching material as set forth in claim 4, wherein the two or more images are similar figures or are of a same series, and an area ratio, a height ratio or a width ratio between the images is consistent with the result values of the fund calculation.

6. The financial calculator teaching material as set forth in claim 1, wherein the financial calculator usage presentation section comprises information about numerical values and buttons that should be actually input to and pressed in the preset model of financial calculator for each of the calculation processes.

7. The financial calculator teaching material as set forth in claim 6, wherein the financial calculator usage presentation section further comprises a financial calculator result screen display section for displaying information displayed on a screen of the preset model of financial calculator when the numerical values and the buttons are input and pressed for each of the calculation processes.

8. The financial calculator teaching material as set forth in claim 1, wherein the financial calculator usage presentation section further comprises at least one financial calculator mode display section for displaying a mode of the preset financial calculator,
wherein details of the financial calculator usage display section correspond to the mode of the financial calculator.

9. The financial calculator teaching material as set forth in claim 1, wherein the financial calculator usage display section further comprises an additional description section for adding matters that require attention or key points.

10. The financial calculator teaching material as set forth in claim 1, wherein the chart is a linear chart,
wherein the linear chart is configured to include at least one of numerical values included in the fund calculation numerical element display section.

11. The financial calculator teaching material as set forth in claim 1, wherein the story is formed of a sentence including one or more numerical values, and at least one of the numerical values constitutes part of the fund calculation numerical element display section.

12. A financial education simulation method, the financial education simulation method being performed through a server connected to a user terminal over a network, the method comprising:
posting a story for each financial situation on a side of a webpage;
displaying a calculator menu, including buttons for inputting numbers and function values and having a financial calculator form, on a side of a webpage;
when buttons provided in the calculator menu are selected through the user terminal connected over the network in accordance with the story, providing a cash flow diagram related to variation in fund to the webpage in accordance with the buttons through the user terminal; and
when an error occurs in any one of a number and a function input through the user terminal, providing notification of the occurrence of the error to the user terminal and requesting correction of the error.

13. The financial education simulation method as set forth in claim 12, wherein the cash flow diagram is a chart which is prepared using an initial value area and a final value area respectively for an initial value of a fund input through the buttons using the user terminal and a final value calculated by applying the function to the initial value.

14. The financial education simulation method as set forth in claim 13, wherein the cash flow diagram further indicates period information that is disposed between a diagram of the initial value and a diagram of the final value chart and is required for the initial value to become the final value.

15. The financial education simulation method as set forth in claim 12, wherein the server sequentially creates images of processes of inputting the numbers and the function value through the calculator menu in accordance with the story and a result value of the cash flow diagram for the input, and provides the images and the result value to the user terminal.

16. The financial education simulation method as set forth in claim 12, wherein the story is a case for any one of a pension, a loan, a periodic rate of return, a retirement plan, a targeted fund, a guaranteed fund and a retirement fund.

17. The financial education simulation method as set forth in claim 12, wherein the calculator menu comprises an interface for a Time Value Money (TVM) calculator.

18. A financial education simulation method, the financial education simulation method being performed through a server connected to a user terminal over a network, the method comprising:
posting a story for each financial situation on a side of a webpage;
displaying a calculator menu, including buttons for inputting numbers and function values and having a financial calculator form, on a side of a webpage;
displaying a cash flow diagram, indicating an initial value and a final value of a fund which are calculated based on the financial situation and a flow of a period required for the variation in the fund, on the webpage; and
when a period and a size of the fund assigned to the financial situation are changed through the user terminal connected over the network, creating the cash flow diagram corresponding to the period and size and providing the cash flow diagram to the user terminal.

19. The financial education simulation method as set forth in claim 18, wherein the server updates the cash flow diagram in accordance with the numbers changed through the calculator menu using the user terminal.

20. The financial education simulation method as set forth in claim 18, wherein the cash flow diagram is a chart which is prepared using an initial value area and a final value area respectively for the initial value of a fund input through the buttons using the user terminal and the final value calculated by applying the function to the initial value.

21. A financial education simulation method, the financial education simulation method being performed through a server connected to a user terminal over a network, the method comprising:
posting a story for each financial situation on a side of a webpage;
displaying a calculator menu, including buttons for inputting numbers and function values and having a financial calculator form, on a side of a webpage;
leaving areas for an amount of money and periods of the story blank, and allowing numbers to be entered in the areas through the user terminal connected over the network;
displaying a cash flow diagram, indicating an initial value and a final value of a fund calculated based on the financial situation and a flow of a period required for the variation in the fund, on the webpage; and
when numbers are entered in the areas through the user terminal, updating the cash flow diagram in accordance with the numbers entered through the user terminal.

22. The financial education simulation method as set forth in claim 21, wherein the server:
displays a story list including the story on the webpage; and
posts the story, selected from the story list through the user terminal, on the webpage.

23. The financial education simulation method as set forth in claim 22, wherein the story list comprises pension, a loan, a periodic rate of return, a retirement plan, a targeted fund, a guaranteed fund and a retirement fund.

24. A computer-readable storage medium for storing a method performed in a computer including a processor and memory, the method comprising the steps of:
posting a story for each financial situation on a monitor;
displaying a calculator menu, including buttons for inputting numbers and function values and having a financial calculator form, on the monitor; and
displaying a cash flow diagram, indicating variations in a fund using an area graph, in accordance with the fund and a function selected through the calculator menu.

25. The computer-readable storage medium as set forth in claim 24, wherein the method further comprises the step of, when an error occurs in the fund and the function selected from the calculator menu, displaying a warning message on the monitor.

26. The computer-readable storage medium as set forth in claim 24, wherein the cash flow diagram indicates the fund and a result value to which the fund is changed in accordance with the function over time.

27. The computer-readable storage medium as set forth in claim 24, wherein the story is acquired through a server connected over a network.
